(19) United States
(12) Patent Application Publication
(10) Pub. No.: US 2007/0090184 A1
(43) Pub. Date: Apr. 26, 2007

(54) Debit card package assemblies

(76) Inventors: Margaret R. Lockwood, Westfield, NJ (US); Daniel Jitzchak Mayer, Warren, NJ (US)

Correspondence Address: Domain G. Wasserbauer, Esq.;IDT CORPORATION, 520 BROAD STREET, Newark, NJ, 07102, US

(21) Appl. No.: 11/585,733

(22) Filed: Oct. 24, 2006

Related U.S. Application Data
(60) Provisional application No. 60/729,977, filed on Oct. 25, 2005.

(51) Int. Cl. G06K 5/00; G06K 19/00

(52) U.S. Cl. 235/380; 235/487

(57) ABSTRACT

The present invention relates to card packaging assemblies that have removable portions: a card portion and a carrier portion. Machine readable indicia for activating the card at the point of sale can be located on either portion and such indicia is adapted to be easily readable by such point of sale device. Each of the card and carrier portions can be made selectively removable from one another so as to use the machine readable indicia for activation.

This application claims priority to provisional application No. 60/729,977 entitled “DEBIT CARD PACKAGE ASSEMBLIES” filed Oct. 25, 2005.

### BACKGROUND OF THE INVENTION

1. Field of the Invention

The present disclosure is related to debit or gift (hereinafter “debit”) cards. More particularly, the present disclosure is related to packaging assemblies for debit cards.

2. Description of Related Art

Debit cards for a prepaid service are often sold in retail stores. For example, long distance calling cards are available in many retail stores. Such calling cards include a predetermined dollar amount of telephone service. This predetermined dollar amount is used by using an account number on the calling card. Of course, other non-telephonic debit cards are available.

Such debit cards are often displayed at the sales register or point-of-sale and, as such often come attached to a card carrier for ease of display. Examples of such cards are described in U.S. Pat. Nos. 5,921,584 and 5,720,158.

Since such debit cards are easily concealed, the cards are typically displayed without any value associated thereto. Rather, the card is activated at the point-of-sale to its predetermined dollar amount. These cards are often activated using a magnetic strip positioned on the card itself. The magnetic strip is associated with an account managed by the provider of the service that is the subject of the card.

At the point of activation, the account is increased or charged to the predetermined dollar amount. The use of the card debits this account until the predetermined dollar amount is used. The account can be recharged by purchasing additional amounts via telephone, mail, or the world-wide-web.

It has been found that there is a continuing need for improved debit card packaging assemblies.

### BRIEF SUMMARY OF THE INVENTION

It is an object of the present disclosure to provide a debit card packaging assembly.

It is another object to provide a debit card packaging assembly that includes a card portion selectively removable from a carrier portion, where the carrier portion includes a magnetic strip for activating the card portion.

It is still another object to provide a debit card packaging assembly that includes a card portion, a carrier portion, and a hanger portion, where the card portion is selectively removable from the carrier and/or hanger portions.

It is a further object to provide a debit card packaging assembly that includes a card portion and a carrier portion, where the carrier portion includes a magnetic strip for activating the card portion and the card portion includes a magnetic strip for recharging the card portion.

The above-described and other features and advantages of the present invention will be appreciated and understood by those skilled in the art from the following detailed description, drawings, and appended claims.

### BRIEF DESCRIPTION OF THE SEVERAL VIEWS OF THE DRAWINGS

FIG. 1 is a first side view of an exemplary embodiment of a debit card packaging assembly according to the present disclosure;

FIG. 1A is a first-side view of an exemplary variation embodiment of a debit card packaging according to the present disclosure;

FIG. 2 is a first side view of an alternate embodiment of the debit card packaging assembly of FIG. 1;

FIG. 3 is a first side view of a second exemplary embodiment of a debit card packaging assembly according to the present disclosure; and

FIGS. 4 through 7 illustrate a first side view of alternate embodiments of the debit card packaging assembly of FIG. 3.

### DETAILED DESCRIPTION OF THE INVENTION

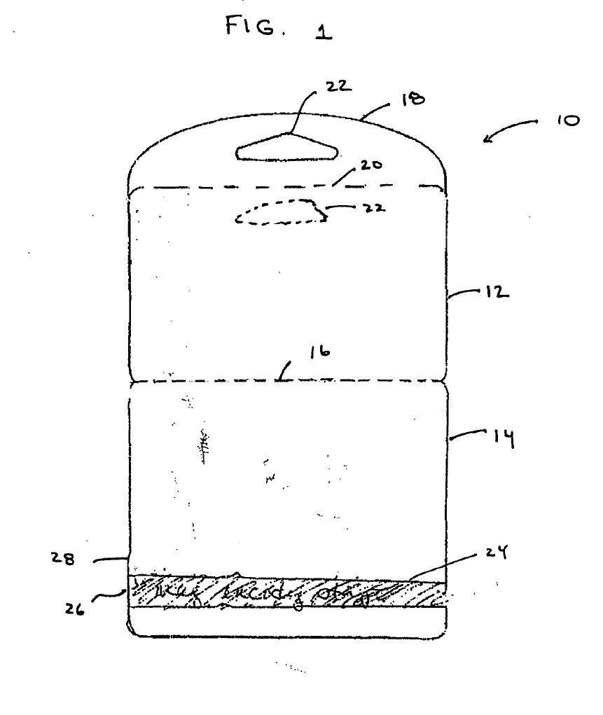

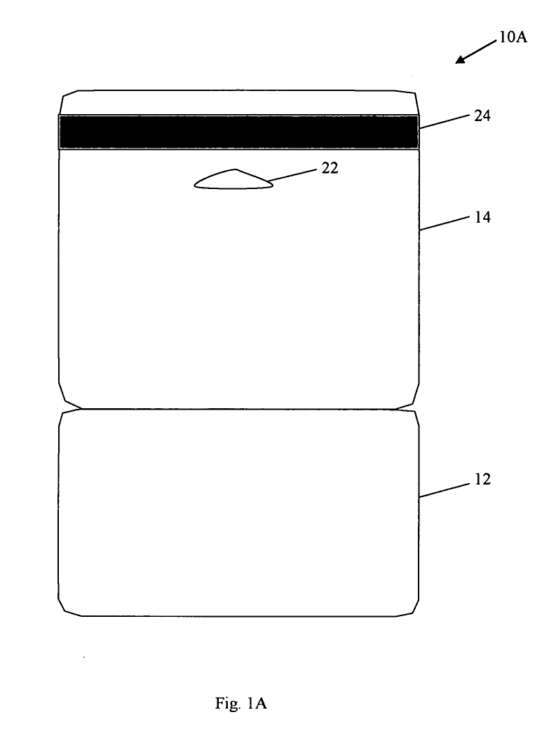

Referring to the drawings and in particular to FIG. 1, a debit card package assembly according to the present disclosure generally referred to by reference numeral 10 is shown. Assembly 10 includes a card portion 12 and a carrier portion 14. Card portion 12 is selectively removable from carrier portion 14. For example, assembly 10 can be formed from a single piece of material that includes a first break or perforation line 16 separating card and carrier portions 12, 14 from one another. In this manner, card and carrier portions 12, 14 can be separated from one another by breaking assembly 10 along a first line 16.

It can be desirable to display assembly 10 at a retail store from a peg or hanger (not shown). Thus, assembly 10 can also include a hanger portion 18. Hanger portion 18 is selectively removable from card portion 12. For example, assembly 10 can be formed from a single piece of material that includes a second break or perforation line 20 separating card and hanger portions 12, 18 from one another. In this manner, card and hanger portions 12, 18 can be separated from one another by breaking assembly 10 along second line 20. Hanger portion 18 also includes an aperture 22 for to enable assembly 10 to be conveniently displayed from the peg or hanger device. It is also contemplated by the present disclosure for aperture 22 to be defined directly in card portion 12 as illustrated in phantom in FIG. 1 so that assembly 10 does not have hanger portion 18.

Carrier portion 14 includes a first or activation magnetic strip 24 defined thereon. Magnetic strip 24 is encoded with activation information (not shown) during the manufacturing process of assembly 10. Magnetic strip 24 is defined so that a leading edge 26 of the magnetic strip 24 abuts an edge 28 of carrier portion 14. In this manner, assembly 10 is configured to activate card portion 12 at the point-of-sale by swiping magnetic strip 24, leading edge 26 first, through a reading device (not shown) without removing carrier portion 14 from card portion 12. The reading device reads the information encoded on magnetic strip 24 to activate card portion 12.

It should be recognized that assembly 10 is described above by way of example having magnetic strip 24 for activation of card portion 12. Of course, it is contemplated by the present disclosure for magnetic strip 24 to be any other type of machine readable indicia such as, but not limited to a bar code, an radio-frequency identification tag, others, and any combinations thereof defined on carrier portion 14.

Assembly 10 has magnetic strip 24 on carrier portion 14, instead of on card portion 12 as in the prior art. In this manner, assembly 10 has all of card portion 12 available for information, other than magnetic strip 24, such as, but not limited to advertisements, government required notices, company logos, instructions for use, and other information.

For example, a typical prior art debit card is sized similar to standard credit cards, namely with a width of about 5.5 millimeters (mm) and a length of about 8.5 mm, which provides each side with a surface area of about 46.75 mm² and a total surface area of about 93.5 mm². In such prior art cards, the magnetic strip has a height of about 1.25 mm and a length of about 8.5 mm for a surface area of about 10.63 mm². As a result, 10% of the available surface area of a prior art debit card is covered by the magnetic strip, leaving approximately 90% for other information. Since assembly 10 incorporates magnetic strip 24 on carrier portion 14, card portion 12, having the same height and length as the prior art cards, has more than 90% of the surface area available for use for other information, more preferably more than 95%, with about 100% being most preferred.

It has also been found by the present disclosure that incorporating magnetic strip 24 on carrier portion 14 enhances the fraud prevention of assembly 10. For example, carrier portion 14 can be removed at the retail store during the activation process. In this manner, assembly 10 can be used to separate the transaction driver, namely magnetic strip 24, from card portion 12 at the point-of-sale. As such, assembly 10 prevents tampering with magnetic strip 24 and, thus, enhances the fraud prevention of card portion 12.

It has further been found that assembly 10 incorporating magnetic strip 24 on carrier portion 14, allows card portion 12 to be formed in non-standard shapes. Prior art debit cards have been limited in size by the magnetic strip itself. Namely, the prior art cards required a shape larger than the magnetic strip and required the card to have a straight edge that abuts the magnetic strip. Advantageously, card portion 12 of assembly 10 can have any desired shape or size.

For example; FIG. 1A depicts an alternative embodiment of the invention for the assembly 10 illustrated in FIG. 1, wherein the function of hanger portion 18 is provided by carrier portion 14, which is the top portion of assembly 10A. Magnetic stripe 24 is located above aperture 22, enabling the activation of the card through swiping that top portion. Card portion 12 is located below carrier portion 14; this arrangement results in a simpler, two-portion assembly 10A, which requires less vertical retail shelf space.

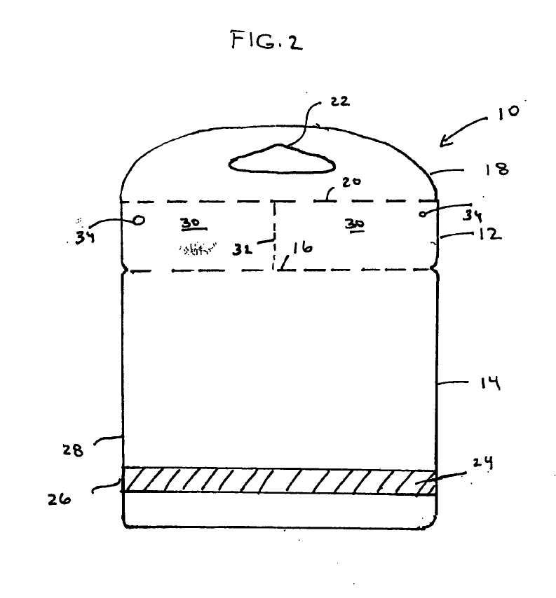

In another example, card portion 12 can be sized as one or more key chain tags 30 as seen in FIG. 2. Key chain tags 30, if more than one is present, can be selectively removable from one another along a third break or perforation line 32. In addition, key chain tags 30 can include second apertures 34 for securing the tag to a user's key ring (not shown). In some embodiments, second aperture 34 can also be used to display assembly 10 at the retail store from the peg or hanger so that assembly 10 does not require, but may have, hanger portion 18.

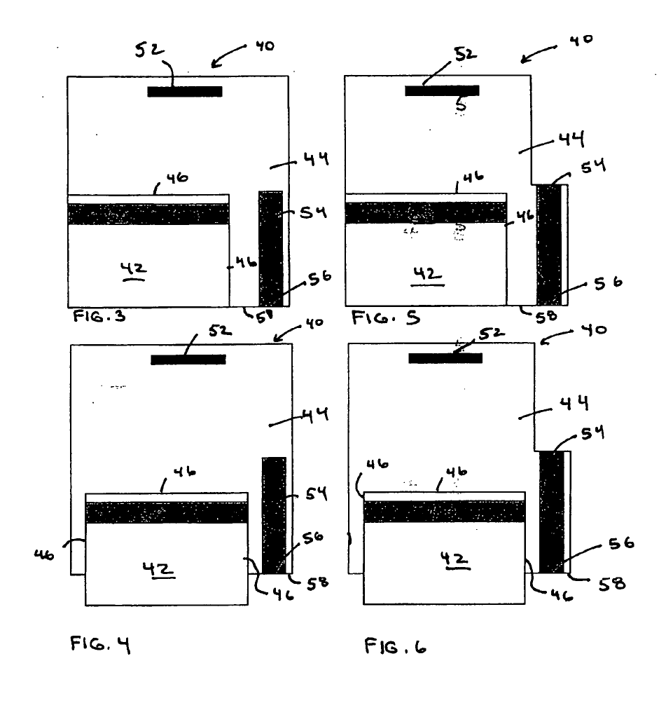

Referring to the drawings and in particular to FIGS. 3 through 6, an alternate embodiment of a debit card package assembly according to the present disclosure generally referred to by reference numeral 40 is shown. Assembly 40 includes a card portion 42 and a carrier portion 44. Card portion 42 is selectively removable from carrier portion 44. For example, assembly 40 can be formed from a single piece of material that includes two or more break or perforation lines 46 separating card and carrier portions 42, 44 from one another. In this manner, card and carrier portions 42, 44 can be separated from one another by breaking assembly 40 along break lines 46.

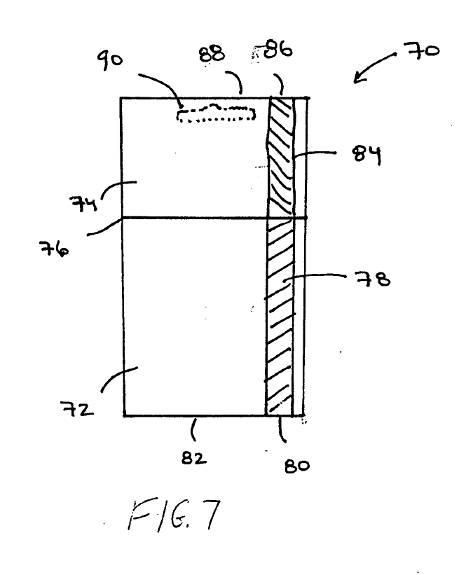

In the embodiments of assembly 40 illustrated in FIGS. 3 and 5, card portion 42 includes two break lines 46. Here, card portion 42 has two edges in common with carrier portion 44. However, in the embodiments of assembly 40 illustrated in FIGS. 4 and 6, card portion 42 includes three break lines 46. Here, card portion 42 has three edges in common with carrier portion 44.

It can be desirable to display assembly 40 at a retail store from a peg or hanger (not shown). Thus, assembly 40 can also include an aperture 52 for to enable assembly 40 to be conveniently displayed from the peg or hanger device.

Carrier portion 44 includes a first or activation magnetic strip 54 defined thereon. Magnetic strip 54 is encoded with activation information (not shown) during the manufacturing process of assembly 40. Magnetic strip 54 has a leading edge 56 that is co-planar with an edge 58 of carrier portion 44. Thus, assembly 40 is configured to activate card portion 42 at the point-of-sale by swiping magnetic strip 54 through a reading device (not shown) without removing carrier portion 44 from the card portion. Assembly 40 can be swiped by inserting leading edge 56 into the reading device. The reading device reads the information encoded on magnetic strip 54 to activate card portion 42.

It may be desired to recharge the account associated with card portion 44. Accordingly, card portion 44 of assembly 40 can, in some embodiments, include a second or recharging magnetic strip 60 defined on the card portion. Magnetic strip 60 is encoded with recharging information (not shown) during the manufacturing process of assembly 40. The recharging information constitutes sufficient embedded data to uniquely associate the card with the account that had been originally provisioned when the card was originally activated through magnetic strip 54. During the recharging process, a checkout clerk swipes magnetic strip 60 through a card reader (not shown) and associates the amount paid by the consumer with that account. The process is similar to that of originally activating a card that does not have an associated predetermined amount, but in the “recharging” case the original account may have a balance, and the total resulting post-charging amount is the sum of the prior balance and the newly paid amount.

Again, it should be recognized that assembly 40 is described above by way of example having magnetic strips 54, 60. Of course, it is contemplated by the present disclosure for magnetic strips 54, 60 to be any other type of machine readable indicia such as, but not limited to a bar code, a radio-frequency identification tag, others, and any combinations thereof.

Referring to FIG. 7, another alternate embodiment of a debit card package assembly according to the present disclosure generally referred to by reference numeral 70 is shown. Assembly 70 includes a card portion 72 and a carrier portion 74. Card portion 72 is selectively removable from carrier portion 74. For example, assembly 70 can be formed from a single piece of material that includes a break or perforation line 76 separating card and carrier portions 72, 74 from one another. In this manner, card and carrier portions 72, 74 can be separated from one another by breaking assembly 70 along break line 76.

Assembly 70 can have a magnetic strip 78 extending longitudinally across card portion 72 and/or magnetic strip 84 extending longitudinally across carrier portion 74. It has been found by the present disclosure that orienting magnetic strips 78, 84 longitudinally with respect to card and carrier portions 72, 74, respectively, allows more assemblies 70 to be positioned at eye level than would be possible in the same display space with prior transversely oriented assemblies.

Magnetic strip 78 can be encoded with activation information and/or recharging information (not shown) during the manufacturing process of assembly 70. Magnetic strip 78 is defined so that a leading edge 80 of the magnetic strip 78 abuts an edge 82 of card portion 72. In this manner, assembly 70 is configured to activate or recharge card portion 72 at the point-of-sale by swiping magnetic strip 78, leading edge 80 first, through a reading device (not shown) without removing carrier portion 74 from the card portion. The reading device reads the information encoded on magnetic strip 78 to activate and/or recharge card portion 72.

In embodiments where magnetic strip 78 is not provided or is encoded with only recharging information, magnetic strip 84 is encoded with activation information.

Magnetic strip 84 has a leading edge 86 that is co-planar with an edge 88 of carrier portion 74. Thus, assembly 70 is configured to activate card portion 72 at the point-of-sale by swiping magnetic strip 84 through a reading device (not shown) without removing carrier portion 74 from the card portion. Assembly 70 can be swiped by inserting leading edge 86 into the reading device. The reading device reads the information encoded on magnetic strip 84 to activate card portion 72.

It can be desirable to display assembly 70 at a retail store from a peg or hanger (not shown). Thus, assembly 70 can also include an aperture 90 defined in carrier portion 74 to enable the assembly to be conveniently displayed from the peg or hanger device.

It should also be noted that the terms “first”, “second”, “third”, “upper”, “lower”, “front”, “back” and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

1. A debit card packaging assembly comprising:
a card portion selectively removable from a carrier portion, wherein said carrier portion includes a first machine readable indicia for activating said card portion.

2. The assembly of claim 1, wherein said card portion does not have machine readable indicia thereon.

3. The assembly of claim 1, wherein said first machine readable indicia is useable to activate said card portion.

4. The assembly of claim 1, wherein said card portion comprises a second machine readable indicia thereon.

5. The assembly of claim 4, wherein said second machine readable indicia is useable to recharge said card portion.

6. The assembly of claim 1, wherein said first machine readable indicia comprises a magnetic strip, a bar code, a radio-frequency identification tag, and any combinations thereof.

7. The assembly of claim 1, further comprising a hanger portion selectively removable from said card portion.

8. The assembly of claim 7, further comprising an aperture defined in said hanger portion.

9. The assembly of claim 1, further comprising an aperture defined in said card portion.

10. A debit card packaging assembly comprising:
a card portion;
a carrier portion; and
a first machine readable indicia for activating said card portion, said card and carrier portions being selectively removable from one another so that said first machine readable indicia is disposed on said card portion longitudinally with respect to the assembly.
